(19) United States
(12) Patent Application Publication
(10) Pub. No.: US 2011/0054662 A1
(43) Pub. Date: Mar. 3, 2011

(54) LAMINATED SUBSTRATE SEPARATING AND ACCOMMODATING DEVICE AND METHOD OF PRODUCING GLASS SUBSTRATES

(75) Inventors: Tomohiro HOSHINO, Tokyo (JP); Takeshi Miyawaki, Tokyo (JP); Haruo Watanabe, Tokyo (JP)

(73) Assignee: Asahi Glass Company, Limited, Chiyoda-ku (JP)

(21) Appl. No.: 12/873,644

(22) Filed: Sep. 1, 2010

(30) Foreign Application Priority Data
Sep. 2, 2009 (JP) 2009-203030

(51) Int. Cl. C03C 19/00; B65G 59/02; G06F 7/00; G06F 19/00

(52) U.S. Cl. 700/114; 65/61; 414/796.8; 700/218; 700/157

(57) ABSTRACT

A stacked substrate separation loading apparatus includes: a stacked substrate holding holder configured to hold a stacked glass substrate; a cassette configured to load each sheet of glass substrates separated from the stacked glass substrate; a liquid tank in which the stacked substrate holding holder and the cassette are inserted in liquid; a stacked substrate drive unit configured to drive the stacked substrate holding holder; a stacked substrate positioning unit which positions a height position of the uppermost sheet of the stacked glass substrate; a cassette drive unit configured to drive the cassette; a substrate sliding mechanism configured to push out and separate the glass substrates which are the top sheets of the stacked glass substrate; and a cassette position control unit configured to control the cassette drive unit so that a height position of a loading position of the cassette becomes a height position of the glass substrate.

### BACKGROUND

1. Field of the Invention

The present invention relates to a stacked substrate separation loading apparatus which is configured so as to effectively separately load glass substrates from a stacked glass substrate with a plurality of glass substrates stacked in a plane direction, and a method of producing glass substrates.

2. Description of the Related Art

For example, in a production process of producing disk-shaped glass substrates, there is a working process of performing working such as grinding and polishing on a plane and end surfaces (inner and outer periphery surfaces) of the glass substrate, and for example, as a method of improving a polishing efficiency of the end surfaces of the glass substrates, there is used a method of forming a stacked glass substrate in which a plurality of sheets (e.g., a few hundreds of sheets) of glass substrates is stacked in a plane direction, thereby concurrently grinding and polishing the end surfaces of many glass substrates.

When the working of the end surface of the stacked glass substrate is finished, in cases where, before shifting to a process of performing grinding and polishing work on plane portions of the glass substrates, the glass substrates are separated from the stacked glass substrate one sheet at a time and the glass substrates are stacked via a spacer, a working of peeling off the spacer, which has been in close contact with the main surface of the glass substrate, to load only the glass substrates in a predetermined cassette is performed. The process of separating the glass substrates from the stacked glass substrate to load the same in the cassette was mainly performed manually by a worker.

However, the manual separating method has problems in that since the planes of the glass substrates are in pressure-contact with each other, the glass substrates cannot be simply separated one sheet at a time, and when the glass substrates are stacked via the spacer made of resin, it is difficult to peel off the spacer which has been in close contact with surfaces of the glass substrates. In addition, in the stacked glass substrate, there are the case of stacking the glass substrates via the spacer therebetween as described above and the case of directly stacking the glass substrates (without the spacer).

Thus, in the related art, as a method of separating the glass substrates from the stacked glass substrate one sheet at a time to load the same in a predetermined cassette, for example, there are proposed a method of separating in which an upper surface side plane of the glass substrate is adsorbed by a jig such as a vacuum adsorption pad, in a state in which the stacked glass substrate is submerged under water in a water tank to pull out and peel off the glass substrate to an upper part as disclosed in JP-A-2008-302448, and a separating way in which an arm for grasping a plurality of places (at least three places) at an end surface of the glass substrate is included and the arm is raised while bring water current into contact with the glass substrate to pull out and peel off the uppermost glass substrate and the spacer from the stacked substrate to the upper part, as disclosed in JP-A-2008-307612, JP-A-2009-48735 and JP-A-2009-48688.

However, in JP-A-2008-302448, JP-A-2008-307612, JP-A-2009-48735 and JP-A-2009-48688, the way of separating by the use of the vacuum adsorption jig or a holding jig for grasping the end surface of the glass substrate has a problem in that, since the glass substrates of the stacked glass substrate come into pressure-contact with each other in a plane direction and are fixedly adsorbed, not only is it is not easy to pull out and peel off the glass substrates in the upper part direction to separate the same and it takes time to perform the separating work, but also the glass substrates must be aggressively pulled out and peeled off, so that a load applied to a portion where the jig comes into contact with the glass substrate when the glass substrates are separated is increased, thereby easily generating a damage to a contact portion of the glass substrate.

In addition, in the way of the related art, in addition to a mechanism for peeling off the glass substrate from the stacked glass substrate, it is necessary to separately provide a special mechanism which adds water pressure between the glass substrates, or irradiates ultrasonic wave, or brings a rotating brush into contact with the glass substrates, or vibrates the stacked glass substrate within the water tank, whereby the overall device was complicated and manufacturing costs were increased accordingly.

### SUMMARY

In view of the above-mentioned circumstances of the present invention, an object of the present invention is to provide a stacked substrate separation loading apparatus and a method of producing glass substrates in which the glass substrates are effectively separated from the stacked glass substrate one sheet at a time to solve the above-mentioned problems.

According to an aspect of the invention, there is provided a stacked substrate separation loading apparatus which separates and loads glass substrates one sheet at a time from a stacked glass substrate in which a plurality of glass substrates is stacked, including: a stacked substrate holding holder configured to hold the stacked glass substrate; a cassette configured to load each sheet of the glass substrates separated from the stacked glass substrate; a liquid tank in which the stacked substrate holding holder and the cassette are inserted in liquid in a direction extending in a vertical direction; a stacked substrate drive unit configured to drive the stacked substrate holding holder in a up and down direction; a stacked substrate positioning unit which positions a height position of the uppermost sheet of the stacked glass substrate held in the stacked substrate holding holder; a cassette drive unit configured to drive the cassette in the up and down direction; a substrate sliding mechanism configured to push out and separate the glass substrates which are the top sheets of the stacked glass substrate from a side direction, one sheet at a time, to load the glass substrates in the cassette; and a cassette position control unit configured to control the cassette drive unit so that a height position of a loading position of the cassette in which the glass substrates are not loaded becomes a height position of the glass substrate pushed out by the substrate sliding mechanism.

The substrate sliding mechanism may include: a pushing jig configured to push out the uppermost glass substrate of the stacked glass substrate in a radial direction to slide the glass substrate to a side part one sheet at a time; and a drive unit configured to drive the pushing jig in a direction which is parallel to a main surface of the glass substrate perpendicular to a stack direction of the stacked glass substrate.

The stacked substrate separation loading apparatus may further include an isolating jig configured to surely separate the glass substrates from the stacked glass substrate by the substrate sliding mechanism one sheet at a time, the isolating jig being provided between the stacked substrate holding holder and the cassette.

The stacked substrate separation loading apparatus may further include a substrate receiving mechanism configured to receive the glass substrates separated from the stacked glass substrate in line with a substrate sliding operation by the substrate sliding mechanism, thereby transporting the glass substrates to the substrate loading position of the cassette.

The stacked substrate positioning unit may include: a stacked substrate positioning cylinder which includes a stacked substrate positioning portion contacting the stacked glass substrate at a front end thereof, the stacked substrate positioning cylinder being configured to move the stacked substrate positioning portion in the up and down direction; a stacked substrate positioning sensor configured to detect a position in which the stacked substrate positioning cylinder is moved in the up and down direction; and a controller configured to drive the stacked substrate drive unit until the uppermost glass substrate of the stacked glass substrate reaches a predetermined height position by detection signal from the stacked substrate positioning sensor.

The cassette position control unit may control the cassette drive unit so that a height position of a loading position performing a substrate receipt of the cassette coincides with a height position of the glass substrate which is the top sheet of the stacked substrate holding holder.

The substrate receiving mechanism may include: a receiving jig configured to mount the glass substrate separated from the stacked glass substrate by the pushing operation of the substrate sliding mechanism; and a drive unit configured to drive the receiving jig in a direction parallel to a main surface of the glass substrate loaded in the cassette.

The pushing jig may be molded by resin in a shape having a contact portion which comes into contact with at least two points of an outer periphery of the glass substrate.

The stacked substrate holding holder may be inserted into the liquid tank in a longitudinal arrangement and at least a portion thereof contacting the glass substrate is formed of resin material.

The cassette may be inserted into the liquid tank in the longitudinal arrangement, and the cassette may be molded by resin in the shape which has a substrate inserting hole through which the glass substrate is loaded at a side facing the stacked substrate holding holder and has an opening through which the receiving jig is inserted and extracted at an opposite side of the substrate inserting hole, or at least the portion contacting the glass substrate may be formed by resin.

The isolating jig may be provided in a transport path which pushes out and separates the glass substrates which is the top sheet of the stacked glass substrate from the side direction, one sheet at a time, by the substrate sliding mechanism, thereby transporting the glass substrates to the cassette, and may be molded by resin so that an upper surface thereof becomes a guide surface for guiding transportation of the glass substrate.

The stacked substrate positioning portion may include a contact portion adapted to come into contact with the upper surface of the glass substrate which is the top sheet of the stacked glass substrate. The contact portion may be molded by resin.

The receiving jig may be molded in a shape having a substrate receiving portion which receives the glass substrate that is separated from the stacked glass substrate and passed through the guide surface of the isolating jig. At least a portion of the receiving jig, where contacts the glass substrate, may be formed by resin material.

The stacked glass substrate may be in the state of being immersed in the liquid of the liquid tank except for the glass substrate which is separated from the stacked glass substrate.

The cassette drive unit may perform descent movement so that the cassette is immersed in the liquid of the liquid tank when the glass substrate separated from the stacked glass substrate is loaded in the cassette, and may drive the cassette so that the glass substrate separated from the stacked glass substrate is immersed in the liquid.

According to another aspect of the invention, there is provided a method of producing of glass substrates including: forming a stacked glass substrate, in which a plurality of glass substrates and a plurality of spacers are alternately stacked or the plurality of glass substrates is stacked; performing polish work of end surfaces of the each glass substrates of the stacked glass substrate; separating the glass substrates of the uppermost sheet from the stacked glass substrate and loading the separated glass substrates in a cassette by using the stacked substrate separation loading apparatus.

The glass substrates may be glass substrates for a magnetic recording medium.

According to the present invention, it is possible to provide a production method which separates the glass substrates from the stacked glass substrate one sheet at a time effectively and easily without generating damage, can load the glass substrates in a predetermined cassette without generating damage, and has a productivity higher than the method of the related art, and glass substrates which are excellent in quality stability.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view showing an embodiment of a stacked substrate separation loading apparatus according to the present invention;

FIG. 2 is a block diagram showing each control unit and each drive unit of the stacked substrate separation loading apparatus;

FIG. 3 is a front view of the stacked substrate separation loading apparatus;

FIG. 4 is a transverse sectional view taken from along line A-A in FIG. 3;

FIG. 5 is a plane view of a stacked substrate holding holder when seen from an upper part;

FIG. 6 is a left side view of the stacked substrate separation loading apparatus;

FIG. 7 is a right side view of the stacked substrate separation loading apparatus;

FIG. 8A is a plane view showing a standby state of the stacked substrate separation loading apparatus;

FIG. 8B is a plane view showing a start state for pushing out the glass substrate of the stacked substrate separation loading apparatus;

FIG. 8C is a plane view showing an operation process for pushing out the glass substrate of the stacked substrate separation loading apparatus;

FIG. 8D is a plane view showing a state in which the glass substrate of the stacked substrate separation loading apparatus is loaded in a cassette;

FIG. 9A is a diagram which schematically shows process 4;

FIG. 9B is a diagram which schematically shows process 6;

FIG. 9C is a diagram which schematically shows process 8;

FIG. 9D is a diagram which schematically shows process 9;

FIG. 9E is a diagram which schematically shows process 10;

FIG. 9F is a diagram which schematically shows process 11;

FIG. 9G is a diagram which schematically shows process 12;

FIG. 9H is a diagram which schematically shows process 13;

FIG. 9I is a diagram which schematically shows process 14;

FIG. 9J is a diagram which schematically shows process 15; and

FIG. 10 is a flow cart for illustrating an order of a control process carried out by a control device.

### DETAILED DESCRIPTION OF THE INVENTION

Hereinafter, an embodiment for carrying out the present invention will be described with reference to the drawings. Furthermore, the present invention is not limited to contents described in embodiments as described later.

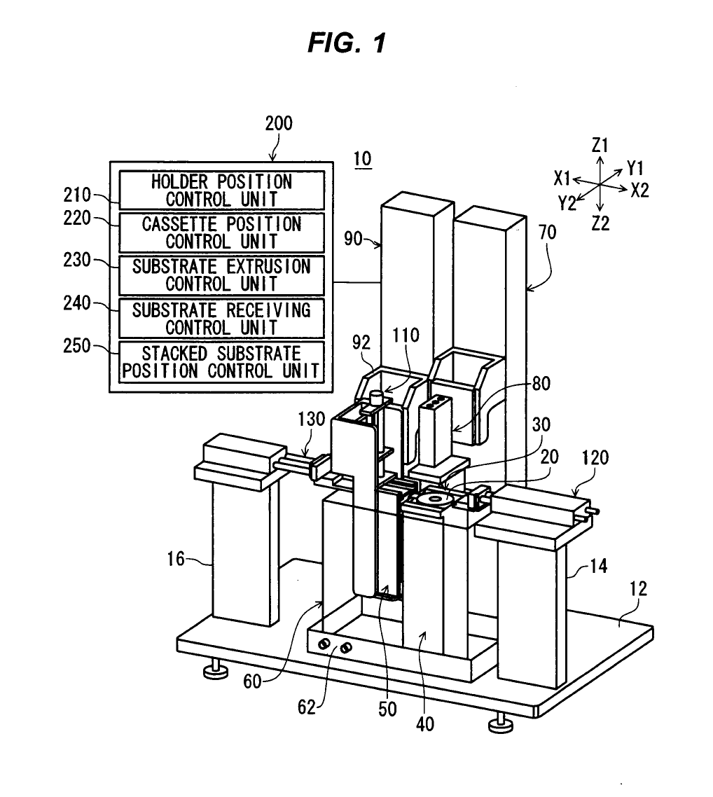

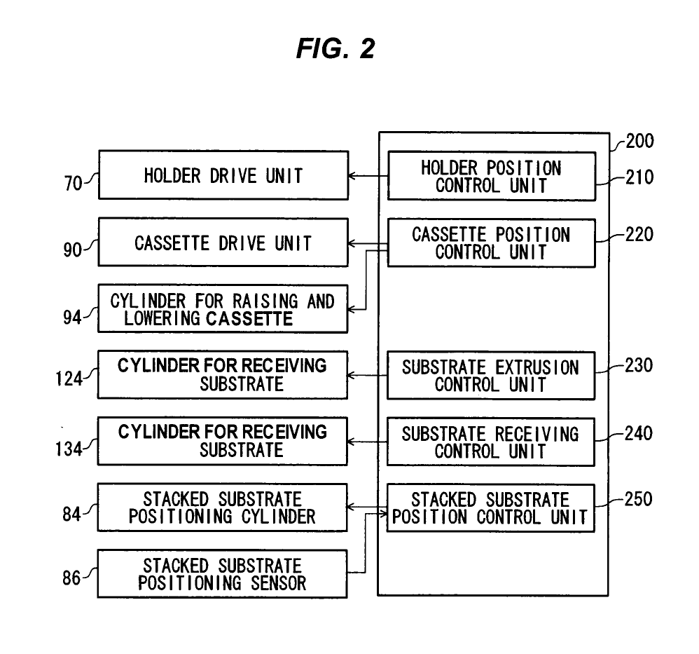

FIG. 1 is a perspective view showing an embodiment of a stacked substrate separation loading apparatus according to the present invention. FIG. 2 is a block diagram showing each control unit and each drive unit of the stacked substrate separation loading apparatus. As shown in FIGS. 1 and 2, a stacked substrate separation loading apparatus 10 is configured so as to separate and load glass substrates 20 from a stacked glass substrate 30, in which a plurality of disk-shaped glass substrates 20 is stacked, one sheet at a time. Furthermore, as the glass substrate 20, for example, there is a glass substrate for a magnetic recording medium.

In addition, the stacked substrate separation loading apparatus 10 has, on a base 12, a stacked substrate holding holder 40, a substrate loading cassette 50, a liquid tank 60, a holder drive unit 70, a stacked substrate positioning unit 80, a cassette drive unit 90, a cassette positioning portion 110, a substrate sliding mechanism 120, a substrate receiving mechanism 130, and a control device 200. The control device 200 includes a computer for performing the respective control processes based on the respective control programs housed in a memory in advance, and has a holder position control unit 210, a cassette position control unit 220, a substrate pushing control unit 230, a substrate receiving control unit 240, and a stacked substrate position control unit 250.

The holder position control unit 210 controls the holder drive unit 70 having an actuator constituted by an air cylinder or the like to raise the stacked glass substrate 30 which was held in the stacked substrate holding holder 40. The cassette position control unit 220 controls the cassette drive unit 90 having the actuator constituted by the air cylinder or the like to adjust a height position of the substrate loading position 52 of the substrate loading cassette 50.

The substrate pushing control unit 230 drives a substrate pushing cylinder 124 of the substrate sliding mechanism 120 to separate the uppermost glass substrate 20 of the stacked glass substrate 30 and loads the separated glass substrate 20 in the substrate loading cassette 50. The substrate receiving control unit 240 drives the substrate receiving cylinder 134 of the substrate receiving mechanism 130 to guide the glass substrate 20 separated from the stacked glass substrate 30 so as to be loaded in a predetermined loading position of the substrate loading cassette 50.

The stacked substrate position control unit 250 detects the height position of the uppermost glass substrate 20 of the stacked glass substrate 30 held in the stacked substrate holding holder 40, so that the glass substrate 20 is positioned at the height position that can be pushed out by the substrate sliding mechanism 120. In addition, the stacked substrate positioning unit 80 has, at a front end thereof, a stacked substrate positioning portion coming into contact with the stacked glass substrate 30, and the stacked substrate positioning unit 80 has a stacked substrate positioning cylinder 84 for moving the stacked substrate positioning portion in an up and down direction and a stacked substrate positioning sensor 86 for detecting a position by which the stacked substrate positioning cylinder 84 has moved in the up and down direction connected thereto. In addition, the stacked substrate position control unit 250 has a controller for driving the holder drive unit 70 by detection signal from the stacked substrate positioning sensor 86 until the uppermost glass substrate 20 of the stacked glass substrate 30 reaches a predetermined height position.

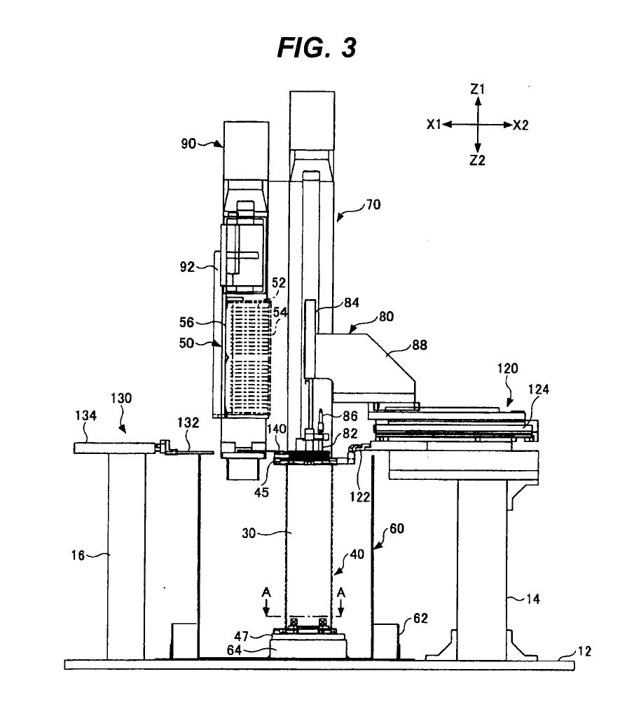

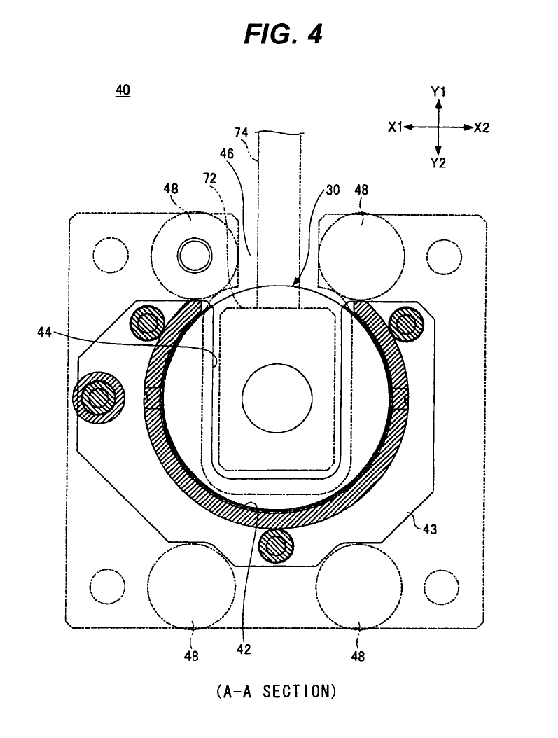

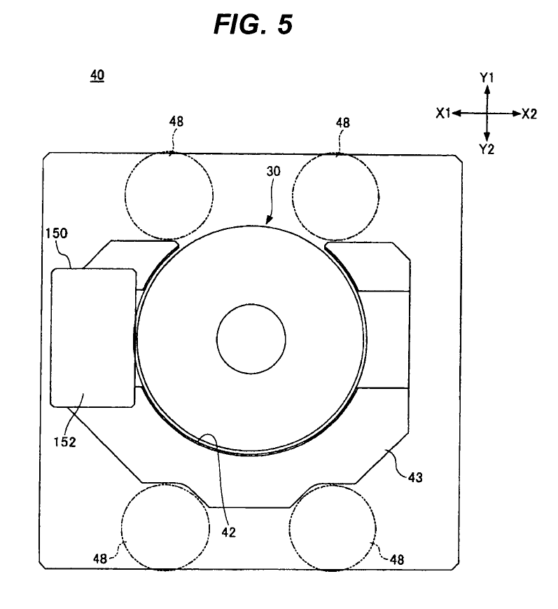

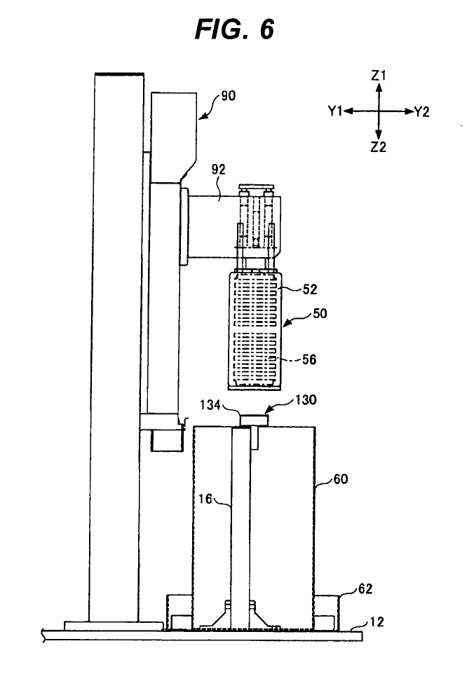

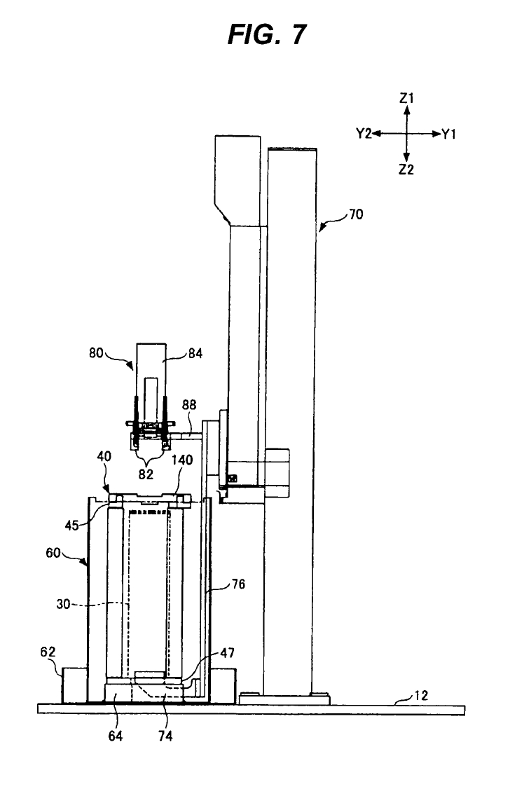

FIG. 3 is a front view of a stacked substrate separation loading apparatus. FIG. 4 is a transverse sectional view along line A-A in FIG. 3. FIG. 5 is a plane view of a stacked substrate holding holder when seen from an upper part. FIG. 6 is a left side view of the stacked substrate separation loading apparatus. FIG. 7 is a right side view of the stacked substrate separation loading apparatus.

Each part that constitutes the stacked substrate separation loading apparatus 10 will be described with reference to FIGS. 3 to 7 in detail.

As shown in FIGS. 3, 6, and 7, the stacked substrate holding holder 40 holds the stacked glass substrate 30 therein and is inserted in liquid of the liquid tank 60 in a vertical state (longitudinally disposed). Moreover, the stacked substrate holding holder 40 is fixed in the state in which a lower end thereof is in contact with a bottom portion of the liquid tank 60, and the stacked glass substrate 30 held therein is maintained movably in the up and down direction (Z1 and Z2 directions). In addition, the stacked glass substrate 30 is driven so as to be gradually raised and moved whenever a substrate separation loading operation described later is performed.

The substrate loading cassette 50 is a container formed of resin in which a plurality substrate loading member 52 for loading the glass substrate 20 separated from the stacked glass substrate 30 one sheet at a time is arranged in the up and down direction. Furthermore, the substrate loading cassette 50 is inserted in the liquid tank 60 in a vertical direction (longitudinally disposed), on a right side surface thereof facing the stacked substrate holding holder 40, a substrate inserting portion through which the glass substrate 20 is inserted is opened, and on a left side surface thereof facing the substrate receiving mechanism 130, a substrate receiving portion inserting portion 56 through which the substrate receiving portion 132 is inserted is opened. Moreover, most of the substrate loading cassette 50 is situated at an upper part further than the liquid surface of the liquid tank 60 in the state before the start of the substrate separation loading operation, moves to a lower part whenever the glass substrate 20 is separated and loaded, and descends so as to gradually immerse the loaded glass substrate 20 in the liquid of the liquid tank 60.

In the liquid tank 60, in order to prevent the glass substrate 20 from drying, the stacked substrate holding holder 40 and the substrate loading cassette 50 are inserted in a direction extending in the vertical direction, and the liquid is supplied and drained so that the liquid is convected. In the present embodiment, the liquid filtered from the bottom part of the liquid tank 60 is supplied, the liquid overflowing from the upper end of the liquid tank 60 flows out to a liquid tank 62 provided on the outer side of the liquid tank 60, and the liquid of the liquid tank 62 is pushed out outside. As a result, in the liquid tank 60, liquid is always convected from a downward direction to the upper part, whereby, for example, even when foreign matter is generated by the substrate separation loading operation, it is possible to push out the foreign matter to the outer liquid tank 62 by the convection. For that reason, it is possible to prevent the foreign matter from attaching to the stacked substrate holding holder 40 and the glass substrates 20 of the substrate loading cassette 50 inserted into the liquid tank 60. In addition, in order to is periodically remove the foreign matter (glass cullet, polishing abrasive grains or the like) sunken to the bottom of the liquid tank 60, for example, an outlet may be provided on the bottom part of the liquid tank 60, so that the precipitates are pushed out from the outlet to the outside of the tank and the liquid of the liquid tank 60 is periodically exchanged.

In addition, as the liquid which is supplied to the liquid tank 60, although it is not particularly limited, it is possible to use normal water, pure water, functional water (anode water, cathode water, hydrogen water, ozone water, carbonated water or the like) or one in which alkali is added thereto to have alkalinity, one in which acid is added to have acidity, or one in which a surfactant is added to lower a surface tension. Furthermore, the liquid tank 60 may be configured to have a stirring mechanism for stirring the liquid in the liquid tank, or an ultrasonic wave vibrator which irradiates the stacked glass substrate 30 in the stacked substrate holding holder 40 or the glass substrates 20 of the substrate loading cassette 50 with the ultrasonic waves to remove the foreign matter.

The holder drive unit 70 has a substrate mounting portion 72 and a support arm 74 which are controlled by the holder position control unit 210, are inserted into the holder from the bottom part of the stacked substrate holding holder 40 to support the stacked glass substrate 30, and raise and lower the stacked glass substrate 30. Herein, a configuration of the stacked substrate holding holder 40 will be described.

As shown in FIGS. 4 and 5, the stacked substrate holding holder 40 is molded by resin material and is fixed in the state in which a lower part thereof is in contact with a holder installing fixing platform 64 provided on the bottom part of the liquid tank 60. In addition, in an inner part of the stacked substrate holding holder 40, a substrate holding jig 43 having a cylindrical space 42 extending in a longitudinal direction (Z1 and Z2 directions) is held. A holder pressing member 140 for holding the substrate holding jig 43 held in the inner part of the stacked substrate holding holder 40 from an upward direction is attached to the upper end of the stacked substrate holding holder 40.

In the cylindrical space 42 of the substrate holding jig 43, the stacked glass substrate 30, in which an outer peripheral end surface thereof is subjected to polishing work, is inserted in the longitudinal direction, and is attached to the inner part of the stacked substrate holding holder 40 so that it can be inserted and extracted from an upward direction. The cylindrical space 42 penetrates in the up and down direction (Z1 and Z2 direction), and the substrate mounting portion 72 driven by the holder drive unit 70 is inserted in a lower opening 44.

In addition, the stacked substrate holding holder 40 has four supports 48 for restricting the position of the substrate holding jig 43 from the outer side. As shown in FIG. 3, each support 48 stands up in the vertical direction (Z1 and Z2 directions), and both ends are fixed to an upper flange 45 and a lower flange 47 of the stacked substrate holding holder 40.

In addition, the stacked substrate holding holder 40 has a path 46, through which the support arm 74 for supporting a rectangular substrate mounting portion 72 ascends and descends, formed between the side surfaces of the cylindrical space 42. In addition, the path 46 extends in the up and down direction (Z1 and Z2 directions) so as to cover a range (up and down stroke) in which the support arm 74 ascends and descends. Thus, an inner wall of the cylindrical space 42 is formed so as to face an outer peripheral end portion of the stacked glass substrate 30 in the range excluding the path 46.

In addition, it is desirable that a portion of the stacked substrate holding holder 40 with which the glass substrate 20 comes into direct contact be formed of resin, and use a material which has high mechanical strength and does not generate cutting or destruction during use without generating damage to the glass substrate 20, for example, materials selected from poly vinyl chloride, poly acetal resin, polyether ether ketone resin, ultra high molecular weight poly ethylene resin, and 4 fluoroethylene resin.

As shown in FIG. 7, the support arm 74 is joined to the vertical arm 76 inserted into the liquid tank 60 by the holder drive unit 70 provided on a back surface side of the liquid tank 60. The vertical arm 76 extends in the vertical direction, a lower end thereof is connected to the support arm 74, and an upper end thereof is connected to a movable portion of the holder drive unit 70.

On the substrate mounting portion 72 inserted into the stacked substrate holding holder 40, the stacked glass substrate 30 is mounted, and when the support arm 74 and the vertical arm 76 are driven in the up and down direction (Z1 and Z2 directions) by the holder drive unit 70, it is possible to raise and lower the stacked glass substrate 30 held in the cylindrical space 42.

In addition, on the upper part of the stacked substrate holding holder 40, a stacked substrate portioning portion 80 for detecting the position of the uppermost glass substrate 20 of the stacked glass substrate 30 is provided. The stacked substrate portioning portion 80 has a stacked substrate positioning portion 82 coming into contact with the uppermost glass substrate 20 of the stacked glass substrate 30, a stacked substrate positioning cylinder 84 for raising and lowering the stacked substrate positioning portion 82, and a stacked substrate positioning sensor 86 for detecting that the stacked substrate positioning portion 82 comes into contact with the uppermost glass substrate 20 to output detection signal. Furthermore, the stacked substrate positioning cylinder 84 is maintained in a predetermined height position by a bracket 88.

The stacked substrate positioning portion 82 moves upward when it comes into contact with the upper surface of the uppermost glass substrate 20 of the stacked glass substrate 30. When the operation is detected by the stacked substrate positioning sensor 86, compressed air is supplied to the stacked substrate positioning cylinder 84 to press the glass substrate 20 from an upward direction to a downward direction. As a result, the uppermost glass substrate 20 of the stacked glass substrate 30 is positioned at a predetermined height position. In addition, the holder drive unit 70 raises and lowers the stacked glass substrate 30 so that the uppermost glass substrate 20 is positioned at a predetermined height position on the liquid surface by the stacked substrate positioning unit 80.

As shown in FIGS. 3 and 6, the cassette drive unit 90 is a lifting mechanism which immerses the substrate loading cassette 50 maintained in the vertical state via the cassette holding member 92 in the liquid tank 60, or drives the cassette holding member 92 in the up and down direction when the substrate loading cassette 50 is taken out. In addition, after the glass substrate 20 separated from the stacked glass substrate 30 is loaded, the cassette drive unit 90 lowers the substrate loading cassette 50 maintained in the vertical state to a downward direction, one sheet at a time.

The cassette positioning portion 110 performs the positioning so that the substrate loading position 52 into which the glass substrate 20 is inserted next, among a plurality of substrate loading positions 52 provided on the inner part of the substrate loading cassette 50, coincides with a height position where the glass substrate separated from the stacked glass substrate 30 is transported.

In the substrate loading cassette 50, a substrate inserting hole 54 is formed in order for a side surface thereof facing the stacked substrate holding holder 40 to perform the insertion of the glass substrate 20. In the inner part of the substrate loading cassette 50, a plurality of substrate loading positions 52 is arranged in the up and down direction in order for each glass substrate 20 to maintain a predetermined gap when each glass substrate 20 is loaded. The cassette drive unit 90 controls the drive amount by the cassette position control unit 220 so that the height position of the substrate loading position 52 loading the glass substrate 20 among the plurality of substrate loading positions 52 coincides with transportation height position of the separated glass substrate 20 when glass substrate 20 is loaded in the substrate loading cassette 50.

In addition, it is desirable that a portion of the substrate loading cassette 50 with which the glass substrate 20 comes into contact be formed of resin, and uses a material which has high mechanical strength and does not generate cutting or destruction during use without generating damage to the glass substrate 20, for example, materials which are selected from poly vinyl chloride, poly acetal resin, polyether ether ketone resin, ultra high molecular weight poly ethylene resin, and 4 fluoroethylene resin.

As shown in FIG. 3, the substrate sliding mechanism 120 is supported in a predetermined height position by the support 14 standing up on the base 12, and has a substrate contact portion 122 which operates so as to push out and separate the glass substrate 20 situated on the uppermost sheet of the stacked glass substrate 30 from the side part one sheet at a time, thereby loading the glass substrate 20 in the substrate loading cassette 50, and a substrate pushing cylinder 124 for moving the substrate contact portion 122 in a horizontal direction.

The substrate receiving mechanism 130 is supported in a predetermined height position by the support 16 standing up on the base 12, and has a substrate receiving portion 132 with two guide arms which guide the glass substrate 20 separated from the stacked glass substrate 30 to the substrate loading cassette 50 in line with the substrate sliding operation by the substrate sliding mechanism 120, and a substrate receiving cylinder 134 for driving the receiving portion 132 in the horizontal direction.

It is desirable that the substrate contact portion 122 and the substrate receiving portion 132 be formed of a material which is softer than the glass substrate 20 so as not to be damage the glass substrate 20 and, for example, be molded by using resin materials such as poly vinyl chloride, poly acetal resin, polyether ether ketone resin, ultra high molecular weight poly ethylene resin, and 4 fluoroethylene resin, or a portion contacting at least the glass substrate 20 be formed by resin material.

Herein, operation of the substrate sliding mechanism 120 and the substrate receiving mechanism 130 will be described.

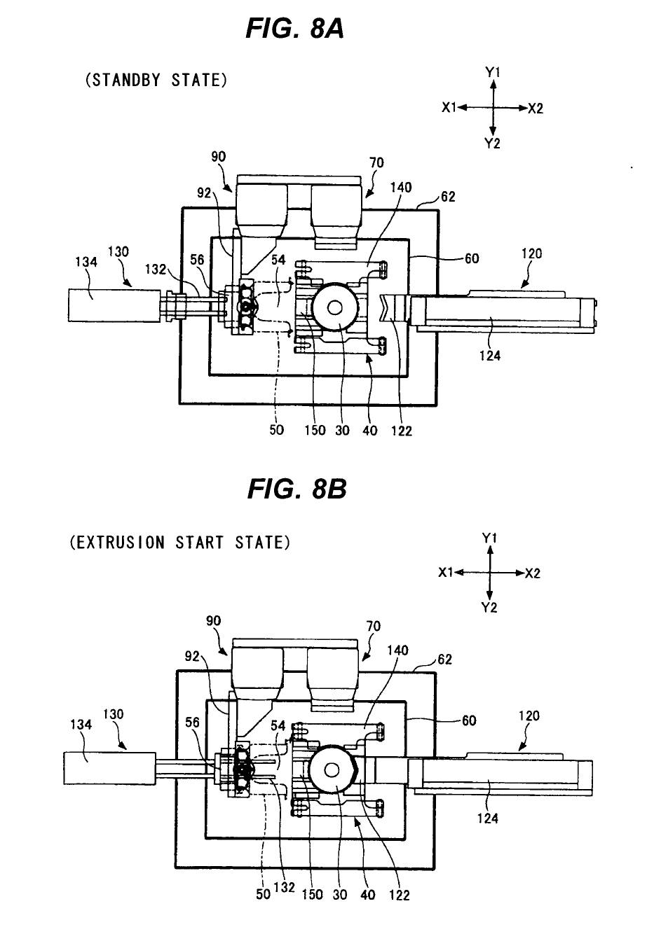

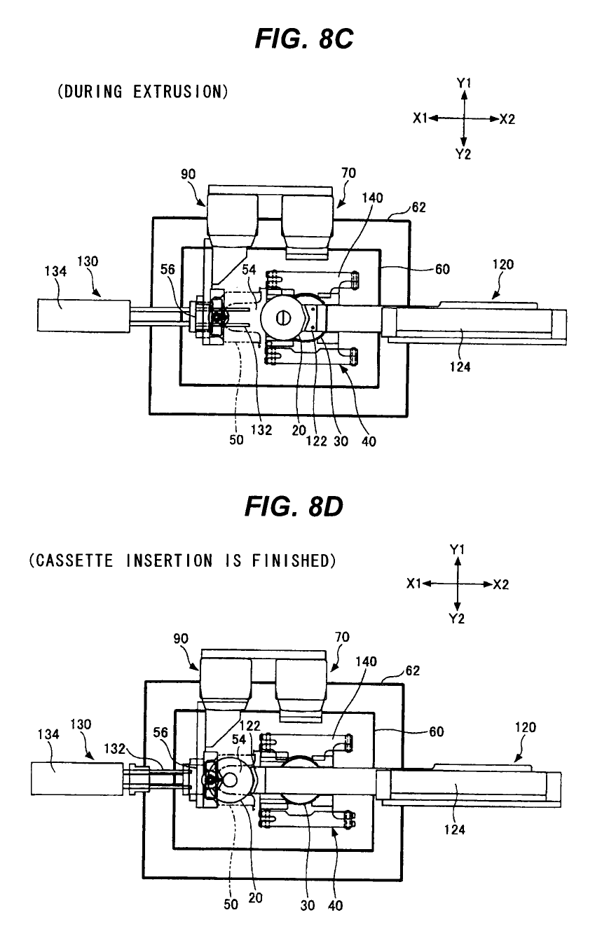

FIG. 8A is a plane view showing a standby state of the stacked substrate separation loading apparatus. FIG. 8B is a plane view showing a start state for pushing out the glass substrate of the stacked substrate separation loading apparatus. FIG. 8C is a plane view showing an operation process for pushing out the glass substrate of the stacked substrate separation loading apparatus. FIG. 8D is a plane view showing a state in which the glass substrate of the stacked substrate separation loading apparatus is loaded in a cassette.

As shown in FIG. 8A, in the state in which a power supply switch or a start switch of the stacked substrate separation loading apparatus 10 is off, the substrate sliding mechanism 120 and the substrate receiving mechanism 130 are in the standby sate, respectively. That is, the substrate contact portion 122 of the substrate sliding mechanism 120 waits at a right side (a X2 direction) of the stacked substrate holding holder 40, and the substrate receiving portion 132 of the substrate receiving mechanism 130 waits at a left side (a X1 direction) of the substrate loading cassette 50.

In the present embodiment, the substrate contact portion 122 of the substrate sliding mechanism 120 has a configuration which is formed in the shape of V when seen from above and comes into contact with two points of the outer periphery of the glass substrate 20. As a shape of the portion of the substrate contact portion 122 with which the outer periphery of the glass substrate 20 comes into contact, it is possible to select an arbitrary shape such as an arched shape, a trapezoid shape, a rectangular shape or the like, without being limited to the above-mentioned V shape.

In addition, an isolating jig 150 disposed closer to the left side surface of the stacked glass substrate 30 is fixed in the upper left side of the stacked substrate holding holder 40. The isolating jig 150 is molded by resin in the rectangular shape, and the upper surface 152 slidably comes into contact with the lower surface of the glass substrate 20 separated from the stacked glass substrate 30, thereby acting as a guide surface for guiding the substrate transporting operation.

Moreover, it is desirable that the isolating jig 150 be formed of resin and uses a material which has high mechanical strength and does not generate cutting or destruction during use without generating damage to the glass substrate 20, for example, materials selected from poly vinyl chloride, poly acetal resin, polyether ether ketone resin, ultra high molecular weight poly ethylene resin, and 4 fluoroethylene resin.

As shown in FIG. 8B, the substrate pushing cylinder 124 of the substrate sliding mechanism 120 drives the substrate contact portion 122 to the left side (the X1 direction) to push out the outer periphery side end surface of the uppermost glass substrate 20 of the stacked glass substrate 30 in a radial direction. At this time, the substrate receiving cylinder 134 of the substrate receiving mechanism 130 drives the substrate receiving portion 132 to the right side (the X2 direction) to insert the substrate receiving portion 132 into the substrate loading cassette 50.

As shown in FIG. 8C, the substrate pushing cylinder 124 of the substrate sliding mechanism 120 further drives the substrate contact portion 122 to the left side (the X1 direction) to push out the uppermost glass substrate 20 of the stacked glass substrate 30. As a result, the uppermost glass substrate 20 which has been in pressure-contact with the stacked glass substrate 30 is pushed out in a radial direction perpendicular to an acting direction of adsorption force of a plane direction, whereby shearing force is generated between the lower surface side and the upper surface (or a spacer formed of resin) of the lower glass substrate 20, so that the glass substrate 20 is easily separated from the stacked glass substrate 30. As a result, since the substrate contact portion 122 pushes out and separates the uppermost glass substrate 20 from the side part of the stacked glass substrate 30 in the radial direction, one sheet at a time, it is possible to effectively separate the glass substrates 20 without damaging the end surface of the glass substrate 20 subjected to the grinding processing.

In addition, the glass substrate 20 is pushed out to the substrate contact portion 122, transported on the upper surface 152 of the isolating jig 150, guided to the upper surface 152 of the isolating jig 150, and transported to the substrate loading cassette 50 side. In order to reduce the transportation resistance of the glass substrate 20 and prevent the drying of the glass substrate 20, water is supplied to the upper surface 152 of the isolating jig 150. For that reason, the glass substrate 20 separated from the stacked glass substrate 30 can smoothly move on the upper surface 152 of the isolating jig 150.

As shown in FIG. 8D, the substrate pushing cylinder 124 of the substrate sliding mechanism 120 drives the substrate contact portion 122 to the left side (the X1 direction) to insert the glass substrate 20 separated from the stacked glass substrate 30 into the substrate loading cassette 50. As a result, the glass substrate 20 separated from the stacked glass substrate 30 is loaded in a predetermined substrate loading position 52 of the substrate loading cassette 50 while being guided to the substrate receiving portion 132 of the substrate receiving mechanism 130. Then, the substrate receiving portion 132 of the substrate receiving mechanism 130 is driven in the X1 direction and is retreated to the left side of the substrate loading cassette 50.

In addition, when the substrate pushing cylinder 124 of the substrate sliding mechanism 120 drives the substrate contact portion 122 to the right side (the X2 direction) and returns to the right side of the stacked substrate holding holder 40, it returns to the standby state shown in FIG. 8A.

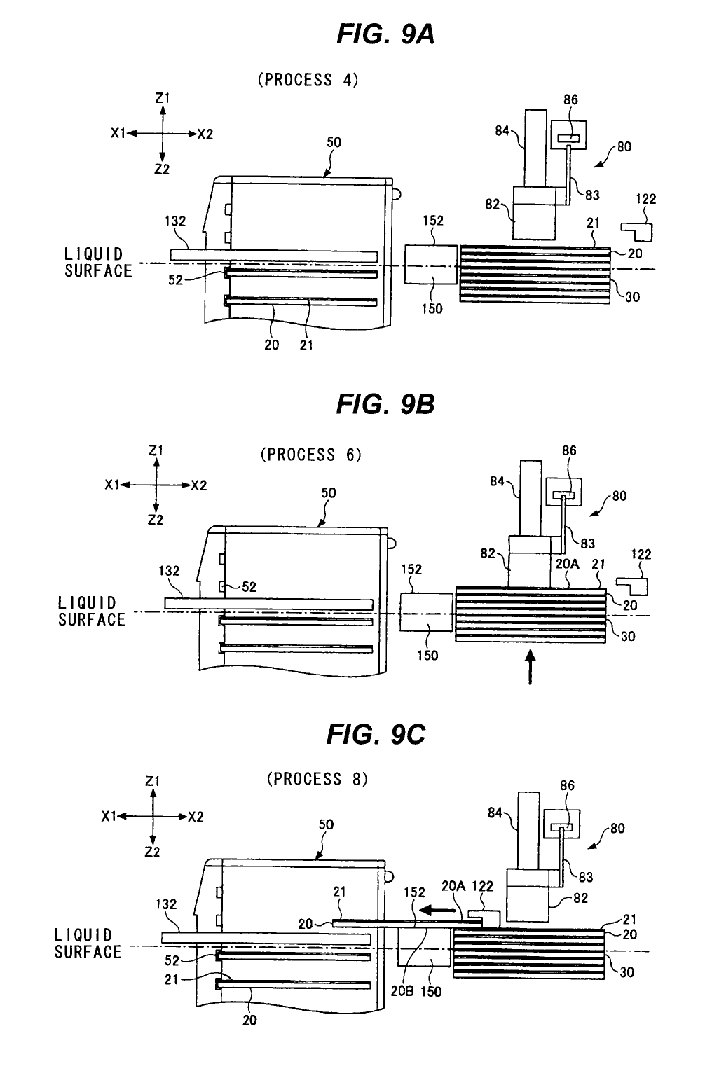

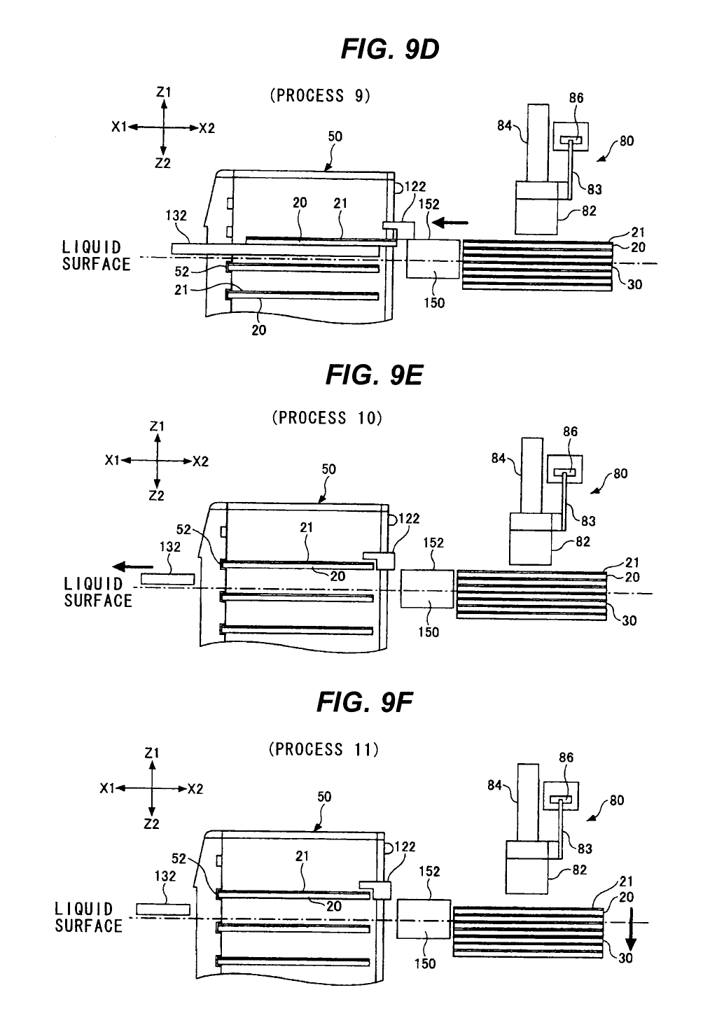

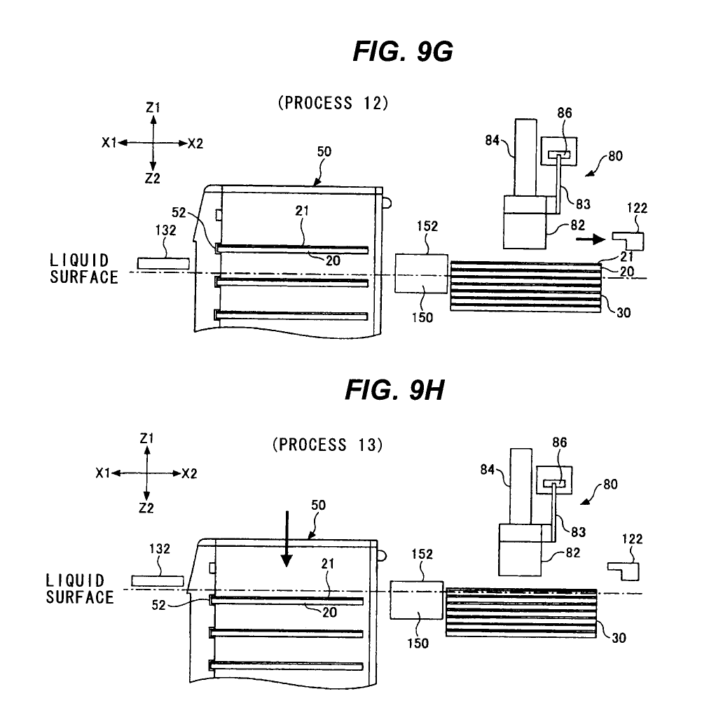

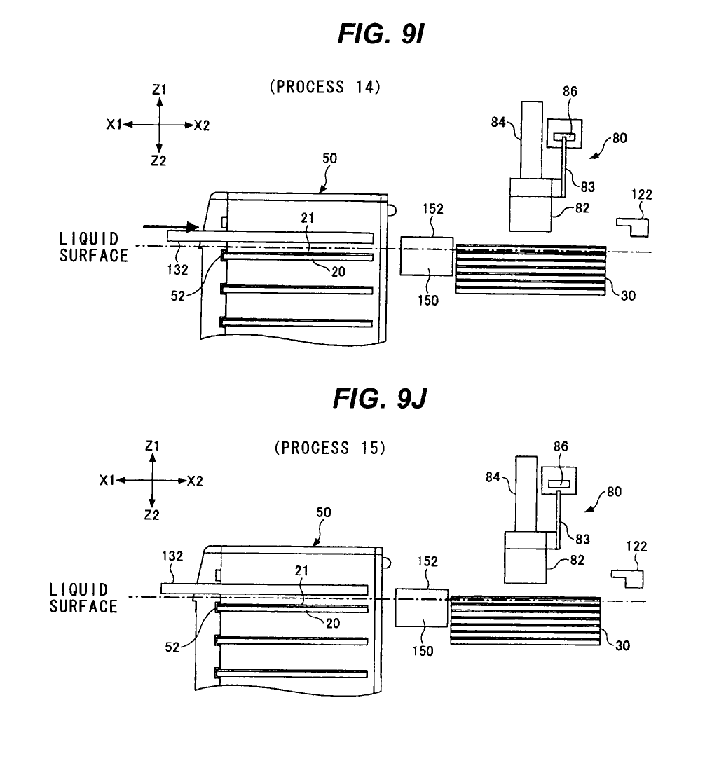

Herein, the positioning operation of the glass substrate 20 by the stacked substrate positioning unit 80 and each process of separation and loading of the glass substrate 20 by the substrate sliding mechanism 120 and the substrate receiving mechanism 130 will be described in detail with reference to processes shown in FIGS. 9A to 9J. Furthermore, in FIGS. 9A to 9J, in order to easily understand the operations of each member, shapes thereof are shown as simplified.

In addition, in FIGS. 9A to 9J, the stacked glass substrate 30 which is stacked in the state in which the spacer 21 formed of resin is present between the glass substrates 20 will be described. However, even when the spacer 21 formed of resin which directly stacks the glass substrates 20 is not present, the same process is performed.

According to process 1, as shown in FIGS. 1, 3 and 7, after the grinding and polishing work processing of the end surface of the stacked glass substrate 30 are performed, the stacked glass substrate 30 is installed in the cylindrical space 42 of the substrate holding jig 43.

According to process 2, as shown in FIGS. 1, 3 and 7, the substrate holding jig 43 with the stacked glass substrate 30 installed thereon is set on the stacked substrate holding holder 40, and the stacked glass substrate 30 is immersed in liquid of the liquid tank 60 in the vertical state.

According to process 3, as shown in FIGS. 1 and 6, the substrate loading cassette 50 of an empty state is set in the cassette holding member 92 of the cassette drive unit 90 and waited on the upper part of the liquid tank 60 in the vertical state. At this time, the substrate sliding mechanism 120 and the substrate receiving mechanism 130 are in the standby state shown in FIG. 8A.

According to process 4, as shown in FIG. 9A, the substrate receiving cylinder 134 of the substrate receiving mechanism 130 drives the substrate receiving portion 132 in the right side (the X2 direction) to insert the substrate receiving portion 132 into the substrate loading cassette 50. In addition, the process 4 is performed when the glass substrate 20 is inserted at the lowest end position of the substrate loading cassette 50. Below the second time, since the substrate receiving portion 132 is inserted into the substrate loading cassette 50 in prior process 14, the process 4 is omitted.

According to process 5, a press-up amount for each time of the stacked glass substrate 30 is set. In the present embodiment, the press-up amount is set by using the upper surface 152 of the isolating jig 150 as a standard surface and using the thickness (or a value of an addition of the thickness of the spacer 21 formed of resin to the thickness of the glass substrate 20) of the glass substrate 20 as the press-up amount to adjust the stacked substrate positioning sensor 86.

According to process 6, as shown in FIG. 9B, the holder drive unit 70 moves the substrate mounting portion 72 inserted into the stacked substrate holding holder 40 to the upper part (a Z1 direction) until reaching a prescribed press-up amount. The stacked glass substrate 30 mounted in the substrate mounting portion 72 rises in the stacked substrate holding holder 40, so that the upper surface (or the spacer formed of resin) of the uppermost glass substrate 20 comes into contact with the stacked substrate positioning portion 82 of the stacked substrate positioning unit 80. The stacked substrate positioning portion 82 is pushed up to the upper part, and an upper end of a detected piece 83 extending to the upper part reaches the detection position of the stacked substrate positioning sensor 86 by the stacked substrate positioning portion 82. The stacked substrate positioning sensor 86 includes, for example, a photo interrupter or the like in which a light emitting element is combined with a light receiving element, and when the detected piece 83 blocks between the light emitting element and the light receiving element, detection signal is output.

According to process 7, when the detection signal is output from the stacked substrate positioning sensor 86, the rising of the stacked glass substrate 30 due to the holder drive unit 70 stops, and the compressed air is supplied to the stacked substrate positioning cylinder 84. As a result, the stacked substrate positioning portion 82 is driven to a downward direction by the stacked substrate positioning cylinder 84 to press the glass substrate 20 of the uppermost sheet of the stacked glass substrate 30. As a result, the glass substrate 20 is pinched and a stop position is stabilized. At this time, the uppermost glass substrate 20 of the stacked glass substrate 30 is subjected to position determination and maintained in the state in which the height position of the lower surface thereof coincides with that of the upper surface 152 of the isolating jig 150.

In addition, the substrate loading cassette 50 is subjected to position determination so that the substrate loading position 52, into which the glass substrate 20 is next inserted among the plurality of substrate loading positions, coincides with the height position where the glass substrate 20 separated from the stacked glass substrate 30 is transported by the cassette positioning portion 110.

In addition, the position where the upper surface 152 of the isolating jig 150 is set as the standard height is situated at the upper part from the liquid surface of the liquid tank 60. Moreover, liquid such as water is supplied to the upper surface 152 of the isolating jig 150 from an upward direction, so that the sliding resistance when glass substrate 20 is transported in the separation direction is reduced.

According to process 8, as shown in FIG. 9C, the substrate pushing cylinder 124 of the substrate sliding mechanism 120 drives the substrate contact portion 122 to the left side (the X1 direction) to press the outer periphery side end surface of the uppermost glass substrate 20 of the stacked glass substrate 30, thereby pushing glass substrate 20 from the stacked glass substrate 30. At this time, the compressed air of the stacked substrate positioning cylinder 84 is removed, so that the stacked substrate positioning portion 82 comes into contact with the glass substrate 20 by its own weight.

The uppermost glass substrate 20 of the stacked glass substrate 30 is pushed out in the radial direction perpendicular to the acting direction of the adsorption force in the plane direction by the pushing operation of the substrate contact portion 122. Thus, shearing force is generated between the lower surface 20B and the upper surface 20A (or the spacer 21 formed of resin) of the glass substrate 20 of a downward direction, whereby the uppermost glass substrate 20 is easily separated from the stacked glass substrate 30. In addition, the isolating jig 150 is close to (or comes into contact with) the left side of the stacked glass substrate 30, so that, when the substrate contact portion 122 pushes out the uppermost glass substrate 20 of the stacked glass substrate 30 in the X1 direction, the stacked glass substrate 30 of the part lower than the uppermost glass substrate 20 is maintained so as not to move in the X1 direction, and the shearing force perpendicular to the adsorption force (pressure contact force) between the glass substrates 20 acts between the lower surface 20B of the uppermost glass substrate 20 and the upper surface 20A of the glass substrate 20 (or the spacer 21 formed of resin) of the second sheet.

In addition, the substrate contact portion 122 is driven to the left side (the X1 direction), and simultaneously, the glass substrate 20 is pushed out, transported on the upper surface 152 of the isolating jig 150, guided to the upper surface 152 of the isolating jig 150, and transported to the substrate loading cassette 50 side.

In addition, the isolating jig 150 is provided on the side, which is opposite to the pushing direction (the X1 direction) due to the substrate sliding mechanism 120, by 180° and is attached so that the upper surface 152 is situated at a position which is lower than the uppermost glass substrate 20 of the stacked glass substrate 30 by one sheet. For that reason, when the substrate pushing cylinder 124 of the substrate sliding mechanism 120 drives the substrate contact portion 122 to push out the uppermost glass substrate 20 of the stacked glass substrate 30 in the left side (the X1 direction), the isolating jig 150 is provided at a position which is close to (or is in contact with) the left side of the stacked glass substrate 30 at the position lower than the uppermost glass substrate 20 of the stacked glass substrate 30.

As a result, when the substrate contact portion 122 pushes out the uppermost glass substrate 20 of the stacked glass substrate 30 in the X1 direction, the stacked glass substrate 30 of a downward direction from the uppermost glass substrate 20 is maintained so as not to move in the X1 direction, and the shearing force perpendicular to the adsorption force (pressure contact force) between the glass substrates 20 acts between the lower surface 20B of the uppermost glass substrate 20 and the upper surface 20A of the glass substrate 20 (or the spacer 21 formed of resin) of the second sheet. It is possible to momentarily separate the uppermost glass substrate 20, which has been pressure-contact with the stacked glass substrate 30, from the stacked glass substrate 30 by the action of the shearing force.

In addition, the glass substrate 20 separated from the stacked glass substrate 30 is transported in the X1 direction while slidably moving on the upper surface 152 of the isolating jig 150.

According to process 9, as shown in FIG. 9D, the substrate pushing cylinder 124 of the substrate sliding mechanism 120 drives the substrate contact portion 122 in the left side (the X1 direction) to insert the glass substrate 20 separated from the stacked glass substrate 30 into the substrate loading cassette 50 while guiding the insertion height by the upper surface 152 of the isolating jig 150. At this time, the glass substrate 20 separated from the stacked glass substrate 30 passes through the upper surface 152 of the isolating jig 150 and is guided to the substrate receiving portion 132 of the substrate receiving mechanism 130 inserted into the substrate loading cassette 50. As a result, the glass substrate 20 is loaded in the predetermined substrate loading position 52 of the substrate loading cassette 50 while the insertion height is guided by the substrate receiving portion 132 of the substrate receiving mechanism 130. Furthermore, the substrate loading position 52 includes grooves formed in the inner wall of the substrate loading cassette 50 and is provided so as to receive the peripheral edge portion of the glass substrate 20.

According to process 10, as shown in FIG. 9E, the substrate receiving cylinder 134 of the substrate receiving mechanism 130 moves the substrate receiving portion 132 in the left side (the X1 direction) to retreat the substrate receiving portion 132 to the left side of the substrate loading cassette 50.

According to process 11, as shown in FIG. 9F, the holder drive unit 70 lowers the substrate dismounting portion 72 inserted into the stacked substrate holding holder 40 in the Z1 direction by a prescribed press-up amount (which is greater than the thickness of the glass substrate 20 or an addition of the thickness of the spacer formed of resin to the thickness of the glass substrate 20). The upper surface of the stacked glass substrate 30 mounted on the substrate mounting portion 72 moves to the position lower than the upper surface 152 (standard position) of the isolating jig 150. As a result, the stacked glass substrate 30 is immersed in the water of the liquid tank 60, so that the uppermost glass substrate 20 is prevented from drying.

According to process 12, as shown in FIG. 9G, the substrate pushing cylinder 124 of the substrate sliding mechanism 120 drives the substrate contact portion 122 in the right side (the X2 direction) to bring the same back to the standby position before the pushing. At this time, since the upper surface of stacked glass substrate 30 descends to the position lower than the upper surface 152 (standard position) of the isolating jig 150, the substrate contact portion 122 does not contact the stacked glass substrate 30 in the course of the return operation of the substrate contact portion 122, whereby the stacked glass substrate 30 can return so as not to damage the glass substrate 20.

According to process 13, as shown in FIG. 9H, the cassette drive unit 90 is driven to lower the substrate loading cassette 50. As a result, the height position of the substrate loading cassette 50 is adjusted by a prescribed press down amount (an mount in which the glass substrate 20 loaded in the cassette 50 is immersed in the liquid or an amount in which the substrate loading position 52 with the substrate loaded therein is immersed in the liquid) in a downward direction by one sheet. The uppermost glass substrate 20 loaded in the substrate receiving portion 52 of the substrate loading cassette 50 is immersed in the liquid of the liquid tank 60 and is prevented from drying.

According to process 14, as shown in FIG. 9I, the substrate receiving cylinder 134 of the substrate receiving mechanism 130 drives the substrate receiving portion 132 in the right side (the X2 direction) to insert the substrate receiving portion 132 into the substrate loading cassette 50.

According to process 15, as shown in FIG. 9J, the compressed air is supplied to the stacked substrate positioning cylinder 84 to lower the stacked substrate positioning portion 82 to a lower limit position and draw the upper end of the detected piece 83 to a downward direction of the stacked substrate positioning sensor 86, thereby bring the stacked substrate positioning unit 80 back to the standby state.

By continuously repeating the processes 5 to 14, the stacked substrate separation loading apparatus 10 can effectively and easily separate the glass substrate 20 from the stacked glass substrate 30 one sheet at a time without generating damage to the glass substrate 20, and can be loaded in the substrate loading cassette 50 without generating damage to the glass substrate 20, whereby it is possible to provide a production method with high productivity and glass substrate 20 with excellent quality stability compared to the method of the related art.

In addition, when the glass substrate 20 is loaded in each substrate loading position 52 of the substrate loading cassette 50, a cassette exchanging work is performed in which the substrate loading cassette 50 is moved to the upper part of the liquid tank 60 by the cassette drive unit 90 and is exchanged with the empty substrate loading cassette 50. The substrate loading cassette 50 with each glass substrate 20 loaded therein is removed from the stacked substrate separation loading apparatus 10 and is transported to the next working process. The substrate loading cassette 50 in which the overall glass substrates 20 are taken out in the next process is installed and used in the stacked substrate separation loading apparatus 10 again.

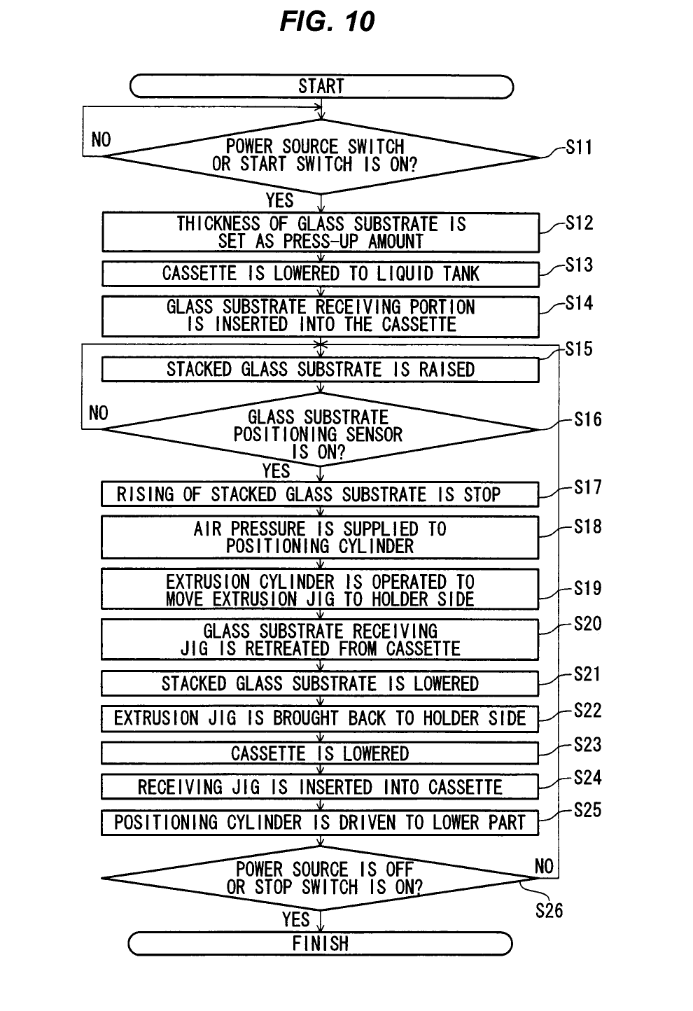

Herein, the control processing carried out by the control device 200 will be described with reference to a flow chart shown in FIG. 10. In S11 of FIG. 10, it is checked whether or not a power source switch or a start switch of the stacked substrate separation loading apparatus 10 is subjected to an on operation. As shown in FIGS. 1, 3 and 7, an operator installs the stacked glass substrate 30 within the cylindrical space 42 of the substrate holding jig 43 and sets the substrate holding jig 43 with the stacked glass substrate 30 installed therein in the stacked substrate holding holder 40 fixed within the liquid tank 60. Next, as shown in FIGS. 1 and 6, the substrate loading cassette 50 of the empty state is set in the cassette holding member 92 of the cassette drive unit 90 and waits in the upper part of the liquid tank 60 in the vertical state.

In addition, when the attachment of the stacked glass substrate 30 and the substrate loading cassette 50 is finished, the operator performs an on operation of the power source switch or the start switch. In S11, when the power source switch or the start switch is subjected to an on operation, process progresses to S12 to set the press-up amount for each time of the stacked glass substrate 30. In the present embodiment, the upper surface 152 of the isolating jig 150 is used as the standard position and the thickness (or a value of the addition of the thickness of the spacer 21 formed of resin to the thickness of the glass substrate 20) of the glass substrate 20 is used as the press up amount to adjust the stacked substrate positioning sensor 86, thereby setting the press-up amount.

In S13, the cassette drive unit 90 is driven to immerse the lower end of the substrate loading cassette 50 in the liquid of the liquid tank 60, and the substrate loading cassette 50 is lowered until the cassette positioning portion 110 detects that the substrate loading position 52 of the lowest end position coincides with the upper surface 152 (standard position) of the isolating jig 150.

In next S14, the substrate receiving cylinder 134 of the substrate receiving mechanism 130 drives the substrate receiving portion 132 in the right side (the X2 direction) to insert the substrate receiving portion 132 into the substrate loading cassette 50 (see FIG. 9A).

In next S15, the holder drive unit 70 is driven to raise the substrate mounting portion 72 and the support arm 74 inserted into the stacked substrate holding holder 40 (see FIG. 9B).

In next S16, it is checked whether or not the stacked substrate positioning sensor 86 detects the detected piece 83, and the rising operation of the stacked glass substrate 30 by S15 is performed until the upper surface (the uppermost glass substrate 20) of the stacked glass substrate 30 comes into contact with the stacked substrate positioning portion 82 of the stacked substrate positioning unit 80, so that the detected piece 83 is detected by the stacked substrate positioning sensor 86.

In S16, when the stacked substrate positioning sensor 86 detects the rising of the detected piece 83 (in the case of YES), the process progresses to S17 and the driving of the holder drive unit 70 is stopped. Next, the process progresses to S18, the stacked substrate positioning cylinder 84 is supplied with the compressed air, and the stacked substrate positioning portion 82 is brought in contact with the uppermost glass substrate 20 of the stacked glass substrate 30 to pinch the glass substrate 20.

In next S19, the substrate pushing cylinder 124 of the substrate sliding mechanism 120 is supplied with the compressed air to drive the substrate contact portion 122 to the left side (the X1 direction), and the outer periphery side end surface of the uppermost glass substrate 20 of the stacked glass substrate 30 is pressed to push out the glass substrate 20 from the stacked glass substrate 30 (see FIGS. 9C and 9D). As a result, the shearing force is generated between the lower surface side and the upper surface 20A (or the spacer 21 formed of resin) of the lower glass substrate 20, whereby the uppermost glass substrate 20 of the stacked glass substrate 30 is easily separated from the stacked glass substrate 30.

Next, the process progresses to S20, the driving direction of the substrate receiving cylinder 134 of the substrate receiving mechanism 130 is changed to drive the substrate receiving portion 132 in the left side (the X1 direction), thereby retreating the substrate receiving portion 132 from the substrate loading cassette 50 (see FIG. 9E).

In next S21, the holder drive unit 70 is driven to lower the substrate mounting portion 72 and the support arm 74 inserted into the stacked substrate holding holder 40, thereby moving the upper end of the stacked glass substrate 30 to the position lower than the upper surface 152 (standard position) of the isolating jig 150 (see FIG. 9F).

In S22, the driving direction of the substrate pushing cylinder 124 of the substrate sliding mechanism 120 is changed to drive the substrate contact portion 122 in the right side (the X2 direction), and the substrate contact portion 122 is brought back to the standby position of the right side part of the stacked substrate holding holder 40 (see FIG. 9G).

Next, the process progresses to S23, the cassette drive unit 90 is driven to lower the substrate loading cassette 50 by a prescribed press down amount (an amount by which the glass substrate 20 loaded in the substrate loading cassette 50 is immersed in the liquid, or an amount by which the substrate loading position 52 with the glass substrate 20 loaded therein is immersed in the liquid) by one sheet (see FIG. 9H).

In next S24, the substrate receiving cylinder 134 of the substrate receiving mechanism 130 is driven to move the substrate receiving portion 132 in the right side (the X2 direction), thereby inserting the substrate receiving portion 132 into the substrate loading cassette 50 (see FIG. 9I).

In S25, the stacked substrate positioning cylinder is driven to lower the stacked substrate positioning portion 82 to the lower limit position and draw the upper end of the detected piece 83 to a downward direction of the stacked substrate positioning sensor 86, thereby bring the stacked substrate positioning unit 80 back to the standby state (see FIG. 9J).

Next, the process progresses to S26, it is checked whether or not the power source switch is subjected to an off operation or the stop switch is subjected to an on operation. In S26, when the power source switch is on and the stop switch is off (in the case of NO), the above-mentioned S15 to S26 are repeated. By continuously performing the processing of S15 to S26, each glass substrate 20 stacked on the stacked glass substrate 30 is separated from each other one sheet at a time and each glass substrate is effectively loaded in each substrate loading position 52 of the substrate loading cassette 50 sequentially.

Furthermore, in the above-mentioned S26, when the power source switch is off or the stop switch is on (in the case of YES), a series of control processes is finished. Moreover, in the S26, for example, when the stacked glass substrate 30 or the substrate loading cassette 50 is exchanged in advance or in a case where a stop condition of a pushing revolution or the like of the glass substrate 20 is set in advance, it is possible to automatically stop the control processing at the time when the stop condition is satisfied.

In general, the production process of the glass substrate for the magnetic recording medium and the magnetic disc includes the following processes.

(1) After glass material substrates molded by a float method, a fusion method or a press molding method have been worked in the shape of a disk, chamfering work is performed in the inner periphery side surface and the outer periphery side surface. (2) Grinding work is performed in the up and down main planes of the glass substrates. (3) End surface polishing is performed in the side surface portions of the inner periphery and the outer periphery of the glass substrate and the chamfering portion. (4) Polishing is performed in the up and down main planes of the glass substrate. The polishing process may perform only a primary polishing, the primary polishing and a secondary polishing (polishing which uses abrasive grains thinner than the primary polishing) may be performed, and a tertiary polishing (polishing which uses abrasive grains thinner than the secondary polishing) may be performed after the secondary polishing. (5) Precision cleaning of the glass substrate is performed to obtain the glass substrate for the magnetic recording medium. (6) A thin film such as a magnetic layer is formed on the glass substrate for the magnetic recording medium, thereby producing a magnetic disc.

Furthermore, in the production process of the glass substrate for the magnetic recording medium and the magnetic disc, a glass substrate cleaning (a cleaning between the processes) or an etching of the glass substrate surface (an etching between the processes) may be performed between the respective processes. In addition, in a case where high mechanical strength is required for the glass substrate for the magnetic recording medium, a reinforcing process (e.g., a chemical reinforcing process), which forms a reinforcement layer on the surface layer of the glass substrate, may be carried out before the polishing process, or after the polishing process, or between the polishing processes.

In the present invention, the glass substrate for the magnetic recording medium may be amorphous glass, crystallization glass, and tempered glass (e.g., chemical tempered glass) which has a reinforcement layer on the surface layer of the glass substrate. In addition, the glass material substrate of the glass substrate of the present invention may be produced by the float method, may be produced by the fusion method, and may be produced by the press molding method.

The present invention relates to the glass substrate separating process which separates the glass substrate from the stacked glass substrate after the glass substrate end surface portion of the stacked glass substrate is polished by using the glass substrate for the magnetic recording medium as the stacked substrate, regarding (3) the process in which the end surface polishing is performed in the side surface portions of the inner periphery and the outer periphery of the glass substrate and the chamfering portion.

Although the configuration in which one stacked substrate holding holder 40 and one substrate loading cassette 50 are immersed in the liquid tank 60 has been exemplified in the above-mentioned embodiment, in order to improve the working efficiency, it may have a configuration in which a plurality of stacked substrate holding holders 40 and a plurality of substrate loading cassette 50 are immersed in the liquid tank 60 in parallel with each other, and a plurality of substrate sliding mechanisms 120 and a plurality of substrate receiving mechanisms 130 are operated concurrently.

Furthermore, although, as the glass substrate 20 of the present embodiment, one that is used in the glass substrate for the magnetic recording medium has been supposed, it is not limited thereto but may be one other than the glass substrate for the magnetic recording medium. For example, the glass substrate may be a glass substrate for a photo mask, a glass substrate for a display such as a liquid crystal or an organic EL, a glass substrate for optical components such as an optical filter and an optical pickup element, and a substrate for a semiconductor (a silicon substrate, a silicon carbide substrate or the like).

What is claimed is:

1. A stacked substrate separation loading apparatus which separates and loads glass substrates one sheet at a time from a stacked glass substrate in which a plurality of glass substrates is stacked, comprising:
a stacked substrate holding holder configured to hold the stacked glass substrate;
a cassette configured to load each sheet of the glass substrates separated from the stacked glass substrate;
a liquid tank in which the stacked substrate holding holder and the cassette are inserted in liquid in a direction extending in a vertical direction;
a stacked substrate drive unit configured to drive the stacked substrate holding holder in a up and down direction;
a stacked substrate positioning unit which positions a height position of the uppermost sheet of the stacked glass substrate held in the stacked substrate holding holder;
a cassette drive unit configured to drive the cassette in the up and down direction;
a substrate sliding mechanism configured to push out and separate the glass substrates which are the top sheets of the stacked glass substrate from a side direction, one sheet at a time, to load the glass substrates in the cassette; and
a cassette position control unit configured to control the cassette drive unit so that a height position of a loading position of the cassette in which the glass substrates are not loaded becomes a height position of the glass substrate pushed out by the substrate sliding mechanism.

2. The stacked substrate separation loading apparatus according to claim 1, wherein
the substrate sliding mechanism includes:
a pushing jig configured to push out the uppermost glass substrate of the stacked glass substrate in a radial direction, and to slide the glass substrate to a side part one sheet at a time; and
a drive unit configured to drive the pushing jig in a direction which is parallel to a main surface of the glass substrate, and perpendicular to a stack direction of the stacked glass substrate.

3. The stacked substrate separation loading apparatus according to claim 1, further comprising
an isolating jig configured to surely separate the glass substrates from the stacked glass substrate by the substrate sliding mechanism one sheet at a time, the isolating jig being provided between the stacked substrate holding holder and the cassette.

4. The stacked substrate separation loading apparatus according to claim 1, further comprising
a substrate receiving mechanism configured to receive the glass substrates separated from the stacked glass substrate in line with a substrate sliding operation by the substrate sliding mechanism, thereby transporting the glass substrates to the substrate loading position of the cassette.

5. The stacked substrate separation loading apparatus according to claim 1, wherein
the stacked substrate positioning unit includes:
a stacked substrate positioning cylinder which includes a stacked substrate positioning portion contacting the stacked glass substrate at a front end thereof, the stacked substrate positioning cylinder being configured to move the stacked substrate positioning portion in the up and down direction;
a stacked substrate positioning sensor configured to detect a position in which the stacked substrate positioning cylinder is moved in the up and down direction; and
a controller configured to drive the stacked substrate drive unit until the uppermost glass substrate of the stacked glass substrate reaches a predetermined height position by detection signal from the stacked substrate positioning sensor.

6. The stacked substrate separation loading apparatus according to claim 1, wherein
the cassette position control unit controls the cassette drive unit so that a height position of a loading position performing a substrate receipt of the cassette coincides with a height position of the glass substrate which is the top sheet of the stacked substrate holding holder.

7. The stacked substrate separation loading apparatus according to claim 4, wherein
the substrate receiving mechanism includes:
a receiving jig configured to mount the glass substrate separated from the stacked glass substrate by the pushing operation of the substrate sliding mechanism; and
a drive unit configured to drive the receiving jig in a direction parallel to a main surface of the glass substrate loaded in the cassette.

8. The stacked substrate separation loading apparatus according to claim 2, wherein
the pushing jig is molded by resin in a shape having a contact portion which comes into contact with at least two points of an outer periphery of the glass substrate.

9. The stacked substrate separation loading apparatus according to claim 1, wherein
the stacked substrate holding holder is inserted into the liquid tank in a longitudinal arrangement and at least a portion thereof contacting the glass substrate is formed of resin material.

10. The stacked substrate separation loading apparatus according to claim 1, wherein
the cassette is inserted into the liquid tank in the longitudinal arrangement;
the cassette is molded by resin in the shape which has a substrate inserting hole through which the glass substrate is loaded at a side facing the stacked substrate holding holder and has an opening through which the receiving jig is inserted and extracted at an opposite side of the substrate inserting hole, or at least the portion contacting the glass substrate is formed by resin.

11. The stacked substrate separation loading apparatus according to claim 3, wherein
the isolating jig is provided in a transport path which pushes out and separates the glass substrates which is the top sheet of the stacked glass substrate from the side direction, one sheet at a time, by the substrate sliding mechanism, thereby transporting the glass substrates to the cassette, and is molded by resin so that an upper surface thereof becomes a guide surface for guiding transportation of the glass substrate.

12. The stacked substrate separation loading apparatus according to claim 5, wherein:
the stacked substrate positioning portion includes a contact portion adapted to come into contact with the upper surface of the glass substrate which is the top sheet of the stacked glass substrate; and
the contact portion is molded by resin.

13. The stacked substrate separation loading apparatus according to claim 7, wherein
the receiving jig is molded in a shape having a substrate receiving portion which receives the glass substrate that is separated from the stacked glass substrate and passed through the guide surface of the isolating jig; and
at least a portion of the receiving jig, where contacts the glass substrate, is formed by resin material.

14. The stacked substrate separation loading apparatus according to claim 1, wherein
the stacked glass substrate is in the state of being immersed in the liquid of the liquid tank except for the glass substrate which is separated from the stacked glass substrate.

15. The stacked substrate separation loading apparatus according to claim 1, wherein
the cassette drive unit performs descent movement so that the cassette is immersed in the liquid of the liquid tank when the glass substrate separated from the stacked glass substrate is loaded in the cassette, and drives the cassette so that the glass substrate separated from the stacked glass substrate is immersed in the liquid.

16. A method of producing of glass substrates comprising:
forming a stacked glass substrate, in which a plurality of glass substrates and a plurality of spacers are alternately stacked or the plurality of glass substrates is stacked;
performing polish work of end surfaces of the each glass substrates of the stacked glass substrate;
separating the glass substrates of the uppermost sheet from the stacked glass substrate and loading the separated glass substrates in a cassette by using the stacked substrate separation loading apparatus according to claim 1.

17. The method of producing of the glass substrates according to claim 16, wherein
the glass substrates are glass substrates for a magnetic recording medium.
